(19) United States
(12) Patent Application Publication
(10) Pub. No.: US 2016/0128468 A1
(43) Pub. Date: May 12, 2016

(54) COMPUTER SUPPORT STATION

(71) Applicants: Patrick Lafleche, Kalamazoo, MI (US); Jason James Wroblewski, Kalamazoo, MI (US); Curtis Buiskool, Kalamazoo, MI (US); Anthony J. Perry, Chicago, IL (US)

(72) Inventors: Patrick Lafleche, Kalamazoo, MI (US); Jason James Wroblewski, Kalamazoo, MI (US); Curtis Buiskool, Kalamazoo, MI (US); Anthony J. Perry, Chicago, IL (US)

(21) Appl. No.: 14/007,252

(22) PCT Filed: Mar. 26, 2012
(86) PCT No.: PCT/US12/30565

§ 371 Date: Oct. 1, 2014

Related U.S. Application Data
(60) Provisional application No. 61/467,539, filed on Mar. 25, 2011.

(51) Int. Cl. A47B 21/03; A47B 21/02; A61G 7/05; A47B 23/02

(52) U.S. Cl. CPC A47B 21/0314; A47B 23/025; A47B 21/02; A61G 7/0506; A47B 2021/0364

(57) ABSTRACT

A computer support station includes a tray having a work surface, with the tray adapted for mounting to a footboard of a hospital bed and being vertically and/or horizontally adjustable. The station further includes a computer and a display in communication with the computer. A keyboard is supported on the work surface and in communication with the computer.

### CROSS-REFERENCE TO RELATED APPLICATIONS

This application is a national stage application of PCT/US2012/30565 filed Mar. 26, 2012, which claims the benefit to U.S. provisional patent application Ser. No. 61/467,539 filed Mar. 25, 2011, entitled Computer Support Station, the complete disclosure of which is hereby incorporated herein by reference.

### TECHNICAL FIELD AND BACKGROUND OF THE INVENTION

The present application is generally directed to a computer support station and, more particularly, to a computer support station that can be mounted to a patient support, such as a hospital bed.

### SUMMARY

The present invention provides a computer support station that includes a tray having a work surface and which is adapted for mounting to a footboard of a hospital bed. The computer support station is optionally vertically adjustable to allow the height of the work surface to be adjusted to accommodate different users. The station may also include a computer, a display in communication with the computer, and a keyboard supported on the work surface, also in communication with the computer.

In one aspect, the computer is configured for communication with the hospital bed based computer and/or a nurse call station or an EMR system.

In other aspects, the tray may be horizontally adjustable.

In yet a further aspect, the computer support station is combination with a hospital bed, with the tray being horizontally adjustable to a location within the footprint of the bed.

According to other aspects, the computer support station is in combination with a hospital bed, and the computer and display are powered by the bed power supply.

In yet another aspect, the computer comprises a portable computer, and the bed has a bed based computer, with the portable computer in communication with the bed-based computer and operable to control or monitor one or more bed-based components. The bed based computer may also have bed-based applications, with the portable computer operable to upload a bed-based application to the bed-based computer and/or update a bed-based application on the bed-based computer.

According to yet another aspect, the station includes a laptop computer, which provides the computer and the display. Further, the tray has a receptacle, with the laptop computer base housed in the receptacle, and the display extendible from the tray. The keyboard, which is supported on the work surface of the tray, is in communication with the laptop and provides a full size keyboard for the user to operate the laptop computer.

Accordingly, the present invention may be used to control a hospital bed configuration, control treatment protocols at the bed, input admission information and/or changes in patient status, allow a caregiver to chart various biometrics of the patient, used to review X-rays, used to provide written orders and/or, further, may be provided with additional applications to allow communication with other devices in the hospital and to upload applications to the bed-based computer.

Consequently, the computer support station provides bedside care that stays with the patient, which can increase real-time documentation and, further, reduce medical errors. When connected to the hospital bed-based computer, the computer support station may allow a user to upgrade technology or applications into the bed-based computer. Further, the articulatable nature of the computer support station allows the tray to be positioned so that it is within the footprint of the bed to facilitate transportation of the hospital bed and a patient supported thereon. In this manner, the computer support station may provide an extension of the footboard controls and display screen to provide enhanced care for the patient.

These and other objects, advantages, purposes, and features of the invention will become more apparent from the study of the following description taken in conjunction with the drawings.

### DESCRIPTION OF THE FIGURES

FIG. 1 is a perspective view of a computer support station of the present invention mounted to the foot end of a hospital bed;

FIG. 1A is an enlarged perspective view of the tray of the computer support station of FIG. 1;

FIG. 2 is a top perspective view of the computer support station of FIG. 1;

FIG. 3 is another perspective view of the computer support station similar to FIG. 2 showing the tray rotated partially over the bed;

FIG. 4 is a perspective view of the computer support station with the foot end of the bed in a cardiac or chair configuration;

FIG. 5 is an enlarged partial fragmentary view of the computer support station column assembly;

FIG. 6 is an enlarged view of an articulating and locking joint of the column assembly of FIG. 5;

FIG. 7 is an enlarged view of a commercially available infinite locking position mechanism suitable for the joint shown in FIGS. 5 and 6;

FIG. 8 is a perspective view of another embodiment of a computer support station of the present invention shown mounted to the foot end of a hospital bed;

FIG. 9 is a similar view to FIG. 8 illustrating a caregiver using a keyboard supported on the computer support station;

FIG. 10 is a similar view to FIG. 9 illustrating the tray adjusted to a raised position for another caregiver;

FIG. 11 illustrates the tray of the computer support station rotated to a bedside position to allow a caregiver to be closer to the patient supported on the hospital bed;

FIG. 12 illustrates the display screen of the computer mounted in the computer support station in a folded configuration and, further, with the tray rotated over the bed and into the footprint of the hospital bed;

FIG. 13 is a perspective view of the computer support station of FIG. 8 mounted to the foot end of a hospital bed with the bed in a cardiac or chair configuration;

FIG. 14 is another perspective view of the patient support station and bed illustrated in FIG. 13;

FIG. 15 is an enlarged view of the back of the tray with a laptop computer inserted into the tray;

FIG. 16 is an enlarged partial fragmentary view of the column assembly of the patient support station illustrated mounted in the foot end of the hospital bed;

FIG. 17 is an enlarged bottom perspective of the tray illustrating the tray mounting arrangement to the column assembly;

FIG. 18 is an enlarged partial fragmentary view of the back of the tray illustrating a securement device used to secure the laptop in the tray;

FIG. 19 is a top perspective partial fragmentary view of the tray;

FIG. 20 is another bottom perspective view of the tray of the patient support station;

FIG. 21 is a top perspective view of the tray illustrating different configurations of the mouse pad area and keyboard support area;

FIG. 22 is another enlarged top perspective view of the tray illustrating the work surface provided by the tray;

FIG. 23 is a side perspective view of the tray of the patient support station illustrating the tray lowered relative to its lower most position on the column assembly;

FIG. 24 is a rear perspective view of the tray and laptop mounted in the tray of FIG. 23;

FIG. 25 is a perspective view of another embodiment of a computer support station of the present invention;

FIG. 26 is an enlarged perspective of the computer support station of FIG. 25 illustrating the mounting of the display screen to the support column assembly;

FIG. 27 is another perspective view similar to FIG. 26 illustrating a pump mounted to the column assembly of the computer support station;

FIG. 28 is another perspective view of the computer support station of FIG. 25; and

FIG. 29 is yet another perspective view of the computer support station illustrating the tray and display screen moved to another orientation.

### DETAILED DESCRIPTION OF THE PREFERRED EMBODIMENTS

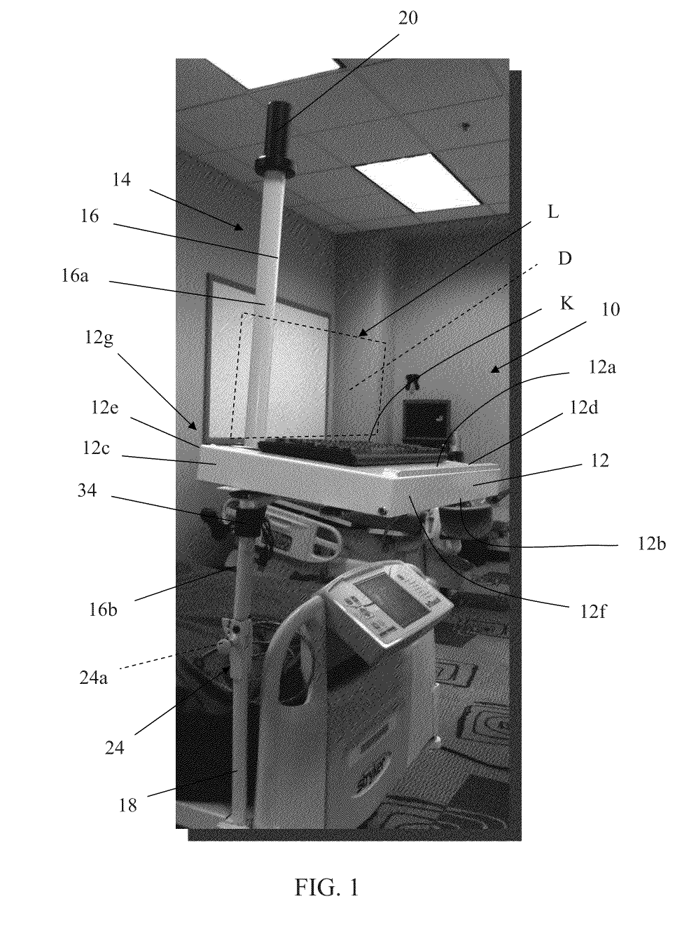

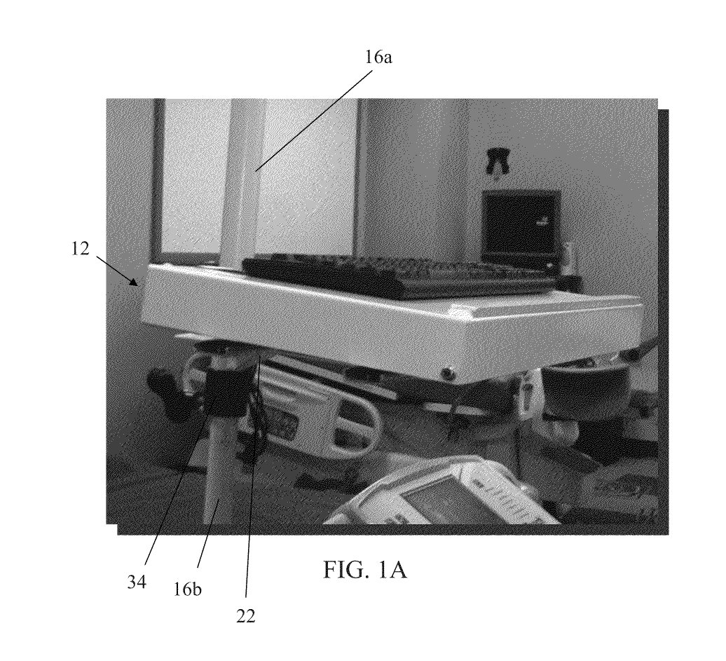

Referring to FIG. 1, the numeral 10 generally designates a computer support station of the present invention. As will be more fully described below, the computer support station allows a person, such as a caregiver, to operate a computer supported by the computer support station, which may provide multiple adjustments to the height or position of the computer supported thereon and, further, may be adapted so it can be reconfigured to a plurality of different configurations to accommodate, for example, the reconfiguration of the bed to which it is attached so that the orientation of the computer can remain the same despite the change in configuration of the bed. While described in reference to being mounted at the foot end of a hospital bed, and more specifically to the footboard of a hospital bed, it should be understood that the support station may be mounted at other locations around a hospital bed and on other patient supports, such as stretchers, emergency cots or the like.

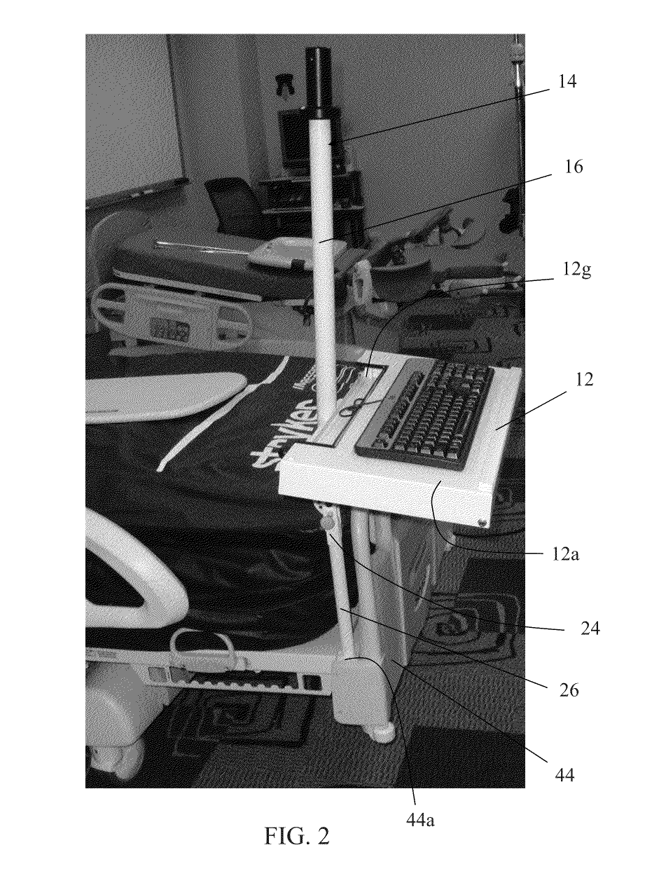

As best seen in FIG. 1, computer support station 10 includes a tray 12, which is mounted to a column assembly 14 and, further, mounted in a manner so that the tray 12 can be adjusted vertically as well as about the vertical axis that extends through the column assembly 14. In the illustrated embodiment, tray 12 comprises a hollow box-shaped structure, which includes a top side 12a on which a keyboard, such as a full size keyboard, can be supported, a bottom side 12b, two opposed sides 12c and 12d, a rearward side 12e, and a forward side 12f. As best seen in FIG. 2, an opening 12g is provided at rearward side 12e to receive the keyboard portion of a laptop, but which permits the display screen D half of the laptop to be extended exteriorly of the tray further positioned so that it extends upwardly from the rearward side 12d of tray 12 for viewing by a person, such as a caregiver, at the forward side 2f of tray 12. As noted, the tray 12, for example by way of top side 12a, may be configured to accommodate a full size keyboard, which is in communication with the laptop, and optionally to provide a working surface, so that a caregiver can input, review, and/or edit data either stored in the laptop or accessible through the laptop, as will be more fully described below. Further, the tray 12, for example at top side 12a, may provide a working surface to allow a caregiver to handle medication or the like.

Tray 12 may be formed from a metal sheet, including an aluminum sheet, which can be welded into its hollow box-shaped configuration. Further, tray 12 may include a cover, including a molded cover, which protects a user from edges of the tray. Additionally, as will be more fully described below, tray 12 may include a wrist rest either mounted, supported, or formed on the tray, such as by molding.

Column assembly 14 may include an articulatable upper portion 16 and a fixed lower portion 18, with upper portion 16 optionally formed from a pair of nesting inner and outer tubular members 16a and 16b, which provide adjustment to the height of tray 12. Optionally mounted in column assembly 14 is a spring, such as gas spring, with one end anchored in inner tubular member 16b and its rod end mounted in outer tubular member 16a. For example, a suitable gas spring includes a variable positioning gas spring, and further a spring that provides step less positioning over the stroke of the spring, such as a gas spring available from Stabilus under the trade name Bloc-O-Lift. For example, the rod end of the gas spring may include a push button, which when compressed allows the spring to be compressed but when released locks the position of the rod end of the spring relative to the gas spring body.

In the illustrated embodiment, to actuate this push button, column assembly 14 includes a handle 20, which is slidably mounted at the upper end of outer tubular member 16a so that when handle 20 is pressed downward, the push button on the spring is compressed to allow the length of the spring to be adjusted and, therefore, allow the position of outer tubular member 16a to be adjusted relative to lower inner tubular member 16b. Referring to FIG. 1A, tray 12 is mounted to outer member 16a by a clamp 22 so that tray 12 moves vertically with the outer tubular member 16a relative to the inner tubular member 16b to thereby allow vertical adjustment of the position of the tray when handle 20 is compressed. When the handle is released, the position of the tray is therefore fixed by the gas spring.

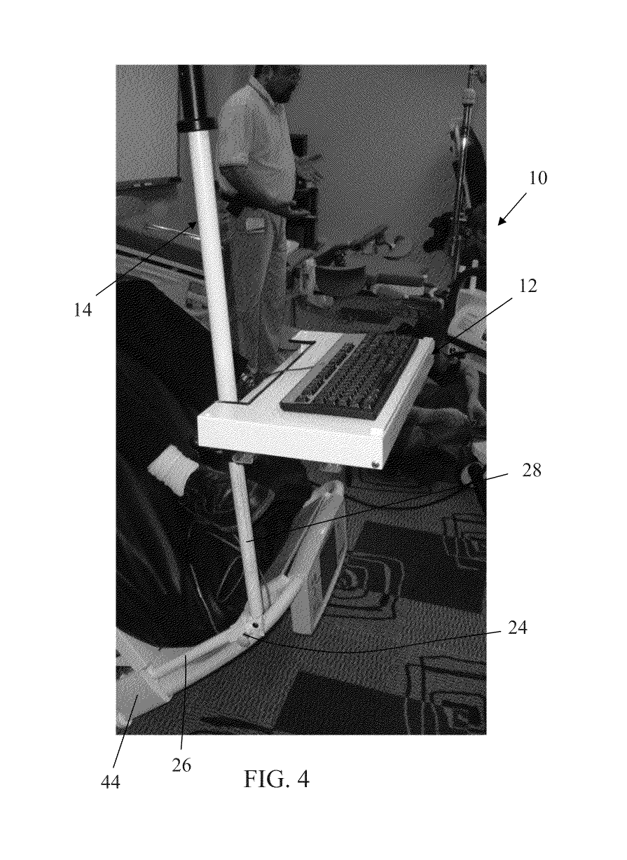

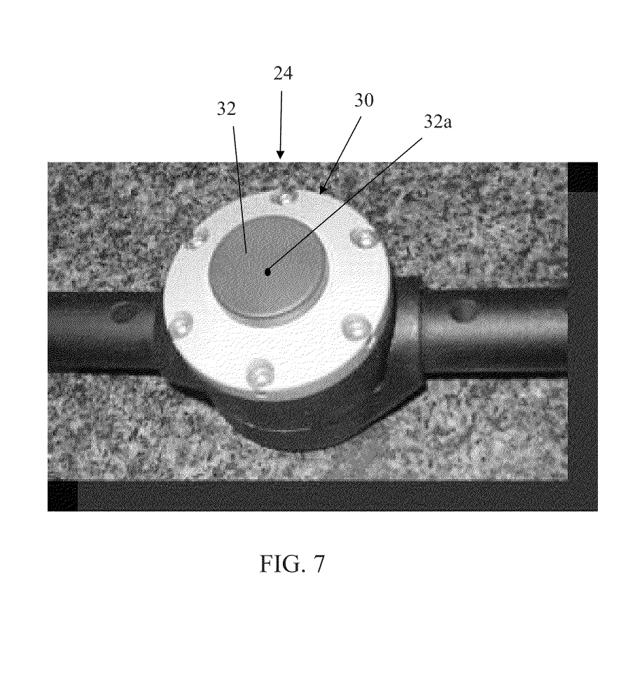

In order to adjust the position of the tray about a horizontal axis, column 14 may include an articulatable joint or connection 24 (FIGS. 1 and 4) between upper portion 16 and lower portion 18, which allows the upper portion 16 to pivot about the horizontal axis 24a (FIG. 1) extending through joint 24. In the illustrated embodiment, joint 24 includes a multiple position hinge that may be fixed in a plurality of positions about its horizontal pivot axis 24a. Optionally, connection 24 may be provided by an infinite locking position mechanism 30 that is available from Reell, which is illustrated in FIG. 7. As best seen in FIG. 7, infinite locking position mechanism 30 includes a spring biased button 32, which when pressed releases the locking mechanism to allow the joint to be rotated about its axis of rotation 32a but locks it in position when button 32 is released. In this manner, when the foot end of the hospital bed is lowered, such as in a cardiac or chair position, the column assembly may be articulated about connection 24 to maintain tray 12 in a generally horizontal position, such as shown in FIG. 4.

To provide torsional rigidity to column assembly 14, column assembly 14 may include a torque control mechanism 34, between outer tubular member 16a and inner tubular member 16b (FIGS. 1 and 1A). A suitable torque control mechanism is available from Reell. In the illustrated embodiment, the torque mechanism is mounted to the upper end of inner tubular member 16b and extends into the lower end of the tubular member 16a to thereby provide rotation between the relative tubular members, but to provide resistance so that while tray 12 and tubular member 16a may be rotated, they only rotate when sufficient force is applied to the tray, which provides added stability to the tray.

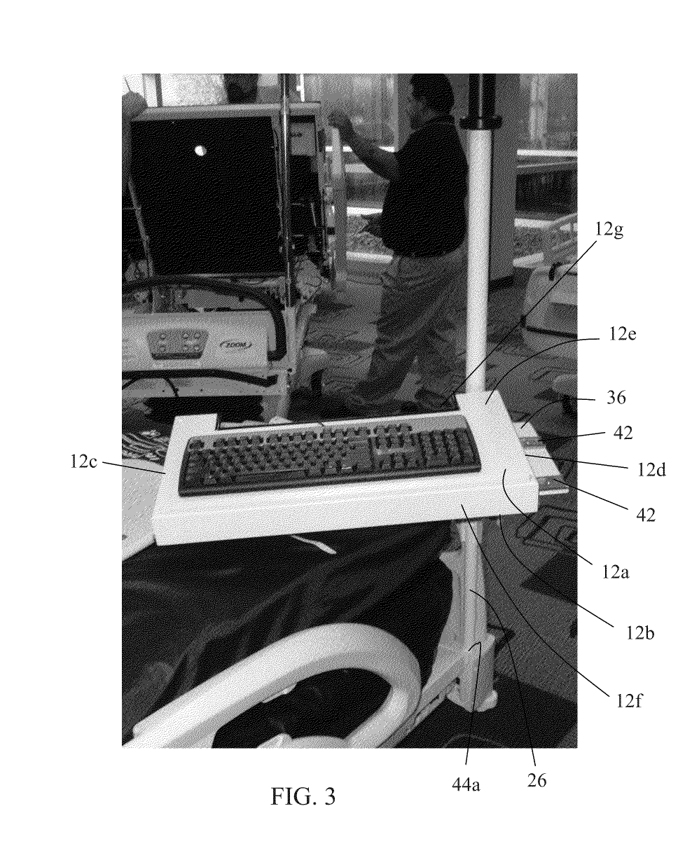

As best seen in FIG. 3, tray 12 is optionally mounted to a base 36 by a pair of rails 42, such as nesting drawer rails, to thereby allow the position of tray 12 to adjust laterally and, thereby provide further adjustment to the positioning of tray 12. To limit the movement of tray 12 relative to the base 36, tray 12 or the base 36 may incorporate a releasable stop to fix the position of the upper tray relative to the base. For example, tray 12 may incorporate an articulatable handle, which engages a corresponding structure on the base to thereby fix the position of the tray relative to the base.

As noted previously, tray 12 is configured to receive a laptop in the tray and to allow the laptop's display screen to be extended up at the back of the tray. In addition, as noted, upper support surface 12a of tray 12 may support a keyboard, which is in communication with the laptop supported in the tray, for example by a cable or a wireless communication, such as RF or infrared communication, to allow a caregiver to use the laptop but with expanded keyboard features. In addition, the laptop may be in communication with the bed computer via cabling or a wireless connection, such as RF or infrared, to monitor the status of the bed or bed components and may provide enhanced control or enhanced options for the bed. Optionally, the laptop may be connected via cabling or a wireless connection, to a nurse call station and/or an emergency medical records (EMR) system so that the laptop supported on computer support station 10 may be used to input records at the bedside to the hospital's EMR system. Further, the laptop may be in communication with devices on the patient to monitor the patient's condition. Thus, the laptop supported on the computer support station may provide enhanced monitoring and/or control of the bed and/or enhanced monitoring and care of a patient.

Optionally, tray 12 may incorporate a battery for powering the laptop. Alternately, the laptop may be connected directly to the power supply on the bed through cabling that may extend through the column assembly or may extend to exteriorly of the column assembly. Optionally, the laptop may be recharged by inductive coupling, for example, when it is moved to its stowed position by an inductive charging system incorporated into the bed.

As previously described, support surface 12a of tray 12 may also provide a surface for a mouse pad, a wrist rest such as shown in FIG. 26, for example and/or, further, may provide space for handling of medications or the like. Additionally, support 10 may incorporate a scanner, which is in communication with the laptop, for scanning bar codes for medication or for scanning the patient's wrist band to correlate the patient with the records accessible via the computer on the EMR. Furthermore, as noted, the laptop computer may communicate with the EMR or with a nurse call station through the communication on the bed. For example, the bed may, therefore, become the hub to which the laptop communicates with the EMR or nurse call station. Any of the above referenced communication may be hardwired or may be provided via a wireless connection. It should be understood, therefore, that the laptop supported by the computer support station may be used to control a hospital bed configuration, control treatment protocols at the bed, provide admission information, such as changes in patient status, allow a caregiver to chart various biometrics of the patient, used to review X-rays, used to provide written orders and/or, further, may be provided with additional applications to allow communication with other devices in the hospital and to upload applications to the bed-based computer. Consequently, the computer support station provides bedside care that stays with the patient, which can increase real-time documentation and, further, reduce medical errors. When connected to the hospital bed computer, the computer support station therefore allows a user to upgrade technology or applications into the bed-based computer. As it will be more fully described in reference to the later embodiments, the articulatable nature of the computer support station allows the tray to be positioned so that it can be moved within the footprint of the bed to facilitate transportation of the hospital bed and patients supported thereon. In this manner, the computer support station may provide an extension of the footboard controls and display screen to provide enhanced care for the patient.

As noted, to facilitate cleaning and, further, soften any edges of the tray, the tray may incorporate a cover, such as a thermo-formed molded cover, or optionally may incorporate a bumper around the perimeter of the tray.

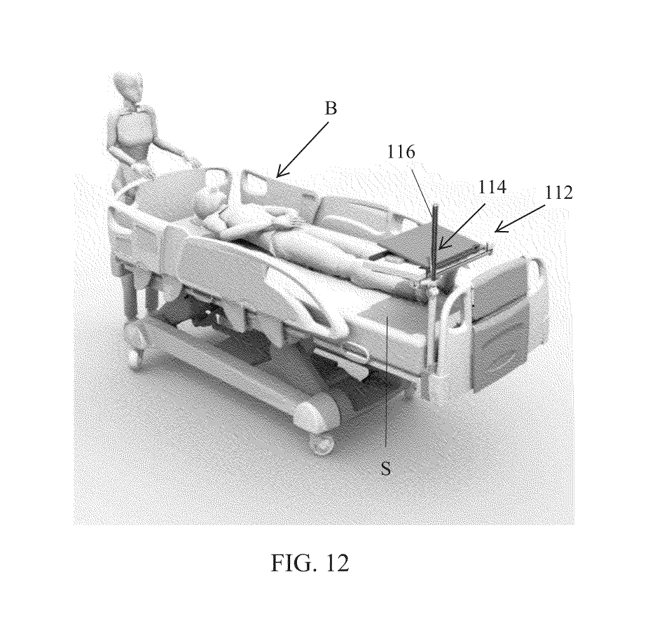

Referring to FIG. 2, the lower end of the column assembly 14 is adapted to insert into the bed. For example, the lower end of the column assembly 14 may be adapted to insert into at the foot end of the bed and, optionally, in a socket 44a provided in footboard 44. For example, either the column assembly or socket or both may incorporate a releasable fastening mechanism to releasably anchor column assembly 14 in the bed. In this manner, tray 12 may be positioned to extend rearwardly of the footboard for easy access by a caregiver or moved to the side of the bed to provide bedside access, but then rotated or pivoted to a stowed position over the surface of the bed, such as shown in FIG. 12. In reference to a further embodiment, additionally as noted and as shown in FIG. 12, the tray may be rotated such that it is within the footprint of the bed. Thus, station 10 may not need to occupy any floor space. Additionally, computer support station 10 makes entry of the data into the computer and, hence, the EMR or nurse call station easier by providing a full sized keyboard and optional mouse.

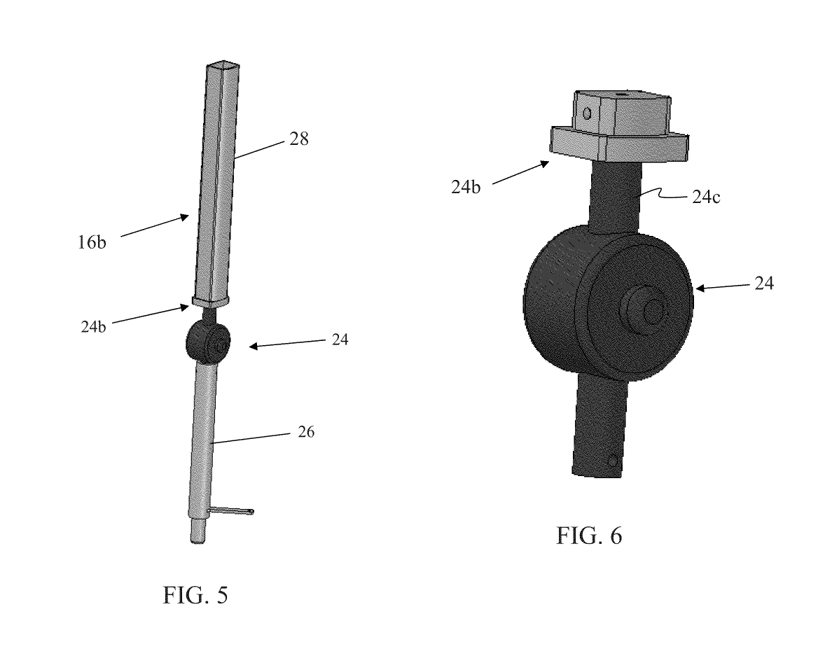

Although illustrated as being formed from round tubular members, the column assembly alternately may incorporate the use of rectangular components. For example, referring to FIG. 5, the articulatable portion 16 of the column assembly 14 may be formed by nested square or rectangular tubular members 28 (only inner tubular member shown), which may increase the torsional resistance of the column assembly. Similarly, although not illustrated, upper tubular member 16a may also have a rectangular or square cross-section to thereby increase the torsional resistance of the column. Joint 24, which connects to the lower inner tubular member 16b, optionally includes torque control mechanism 24a, which mounts to the upwardly extending stem 24b of joint 24, which has a round cross-section, to provide increased torsional resistance while at the same time allowing rotation of the tubular member 28 relative to joint 24 about its longitudinal axis. In this manner, rotation can occur between the articulatable upper member 16 and fixed lower member 18, rather than between outer tubular member 16a and inner tubular member 16b. As noted, suitable torque control mechanisms are available from Reell.

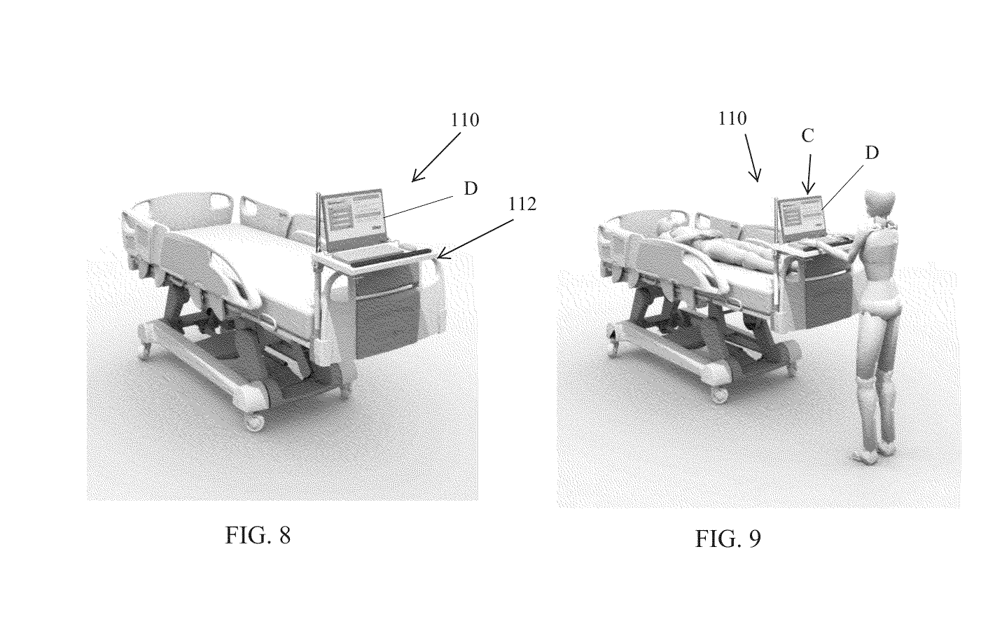

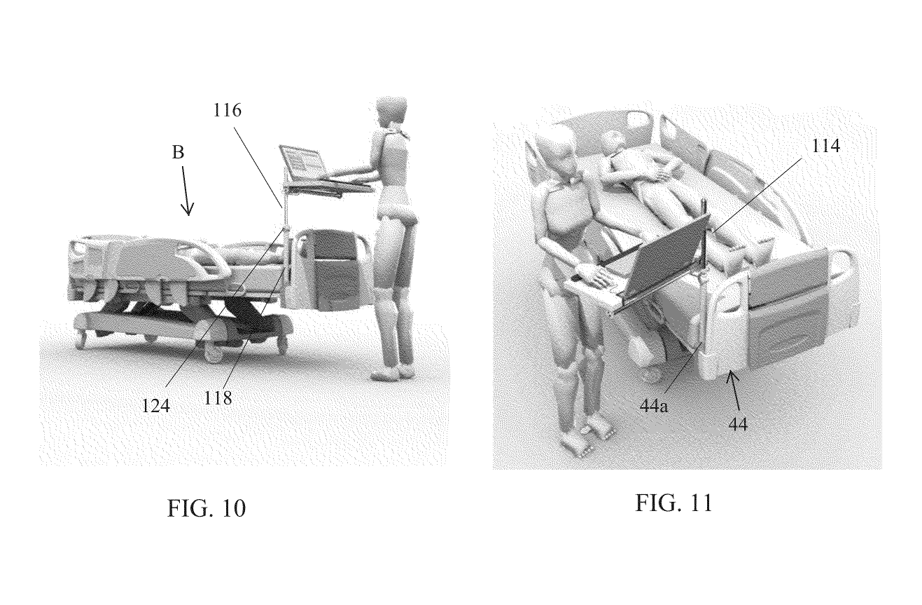

Referring to FIGS. 8-14, the numeral 110 generally designates another embodiment of a computer support station of the present invention. Similar to computer support station 10, computer support station 110 includes a tray 112 (similar to tray 12), which holds a laptop computer, whose display screen D extends upwardly from the back of the tray for viewing by a user, and a keyboard, which is in communication with the laptop to optionally provide a caretaker with a full sized keyboard. Tray 112 is supported by a column assembly 114, which similarly allows a caregiver to move tray 112 to various heights to accommodate different caregiver (FIGS. 9 and 10) and, further, to pivot the tray, for example, to the side of the bed so that the caregiver can input data into the computer while standing closer to the patient (FIG. 11). Additionally, as best seen in FIG. 12, tray 112 can be pivoted so that it extends over the mattress or support surface of the bed and fully substantially contained within the footprint of the bed to facilitate transportation of the bed while station 110 is still attached.

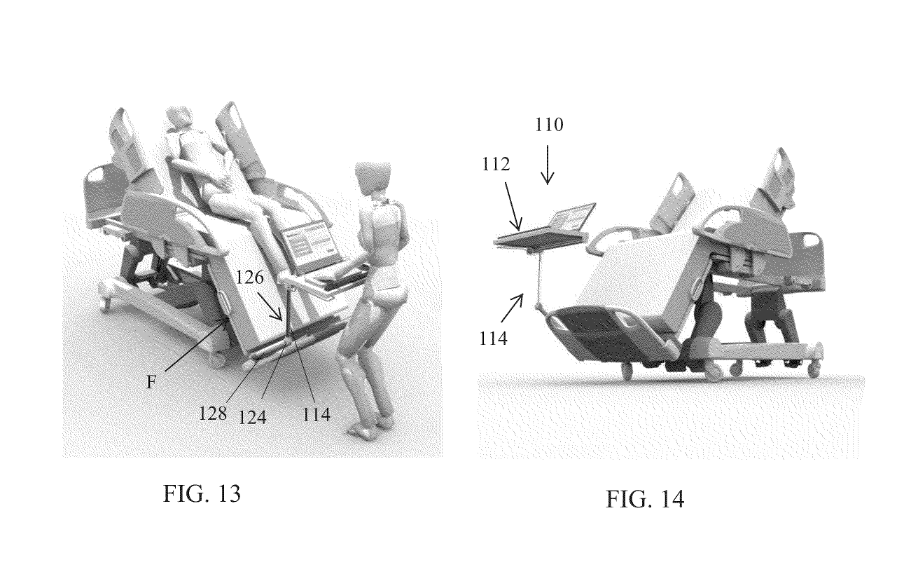

As best seen in FIGS. 10-16, column assembly 114 includes an articulatable upper tubular member 116 and a fixed lower tubular 118, which are joined by a joint 124 similar to joint 24, which allows tubular member 116 to pivot relative to tubular member 118. In this manner, when the foot section of the bed is lowered, for example to a cardiac or chair position, the upper tubular member 116 may articulated to maintain tray 112 in a generally horizontal position, such as shown in FIGS. 13 and 14. Further, the height of column assembly 114 may be increased to assure that most, if not all, caregivers can stand while using the keyboard and without having to bend. The lower end of the lower portion of the column assembly 114 also extends into and is received and secured in a socket 44a of footboard 44 to thereby releasably anchor station 10 to the bed.

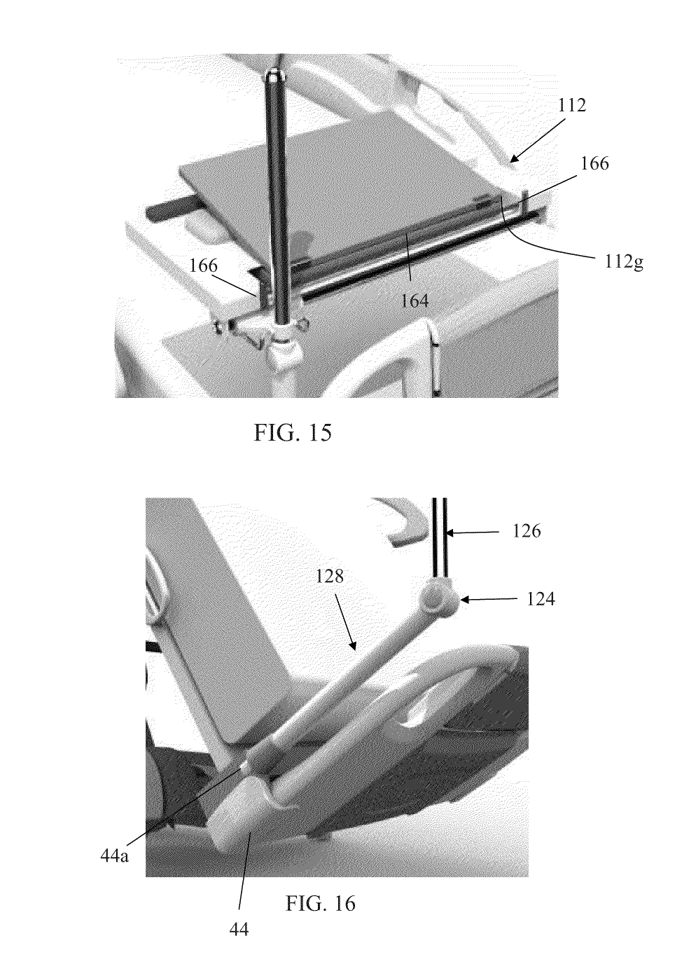

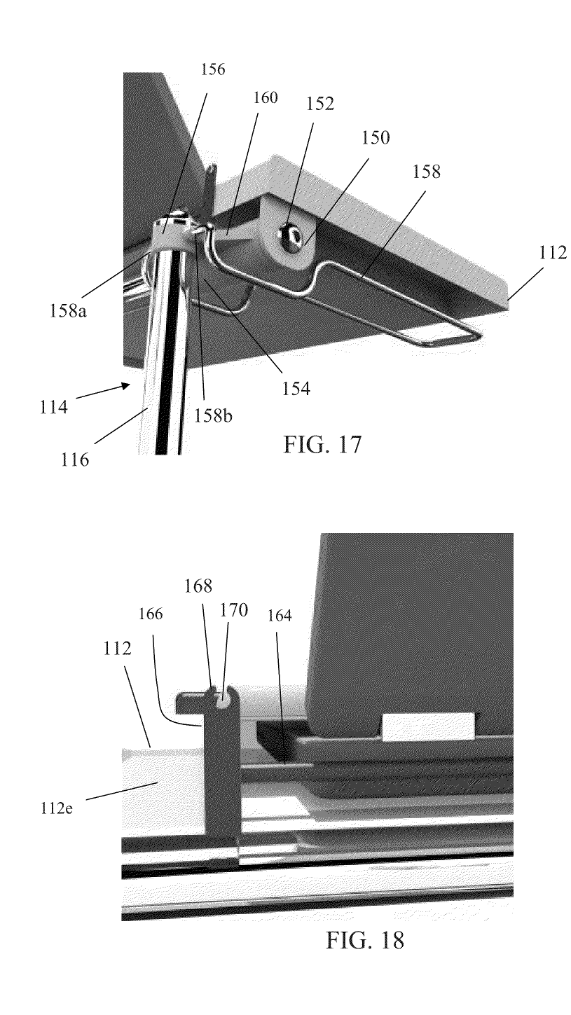

Referring to FIGS. 15, 17, and 20, tray 112 includes a pair of downwardly depending flanges 150 and a rod 152, which extends between and is supported by flanges 150 to form a mount for tray 112 to column assembly 114. Extending inwardly from the left hand flange 150, as viewed in FIG. 20, is a collar 154, which supports a sleeve 156 that extends around upper tubular member 116 to thereby mount tray 112 to tubular member 116. Sleeve 156 supports a generally U-shaped lever or handle 158 with inwardly extending arms 158a, 158b that extend through sleeve 156 into tubular member 116 for engagement with the push button on the rod end of the gas spring, which is located inside column assembly 114 (similar to the previous embodiment). Sleeve 156 is mounted to collar 154 by a web 160, which provides reinforcement for the mounting connection of tray 112 to column assembly 114. Thus, when lever 158 is lifted (or alternately lowered depending on the configuration of the arms 158a, 158b) as viewed in FIG. 17, the push button on the gas spring is compressed and tubular member 116 can be lowered or raised relative to lower tubular member 118 to allow the height of tray 112 to be adjusted.

Referring to FIGS. 15 and 18, the laptop may be secured in the tray for example, by a transverse bar 164 that extends across the rearward facing opening 112g of tray 112. Optionally, a lock may be provided to lock the transverse bar in place to prevent an unauthorized person from removing the laptop from the tray. In addition, line management devices may be provided at the back 112e of tray 112. For example, as best seen in FIG. 18, upwardly extending tabs 166 with a C-shaped ends 168, which form recesses 170 for receiving wiring, cabling or the like, may be mounted to the back of the tray and, further, may be incorporated into transverse bar 164.

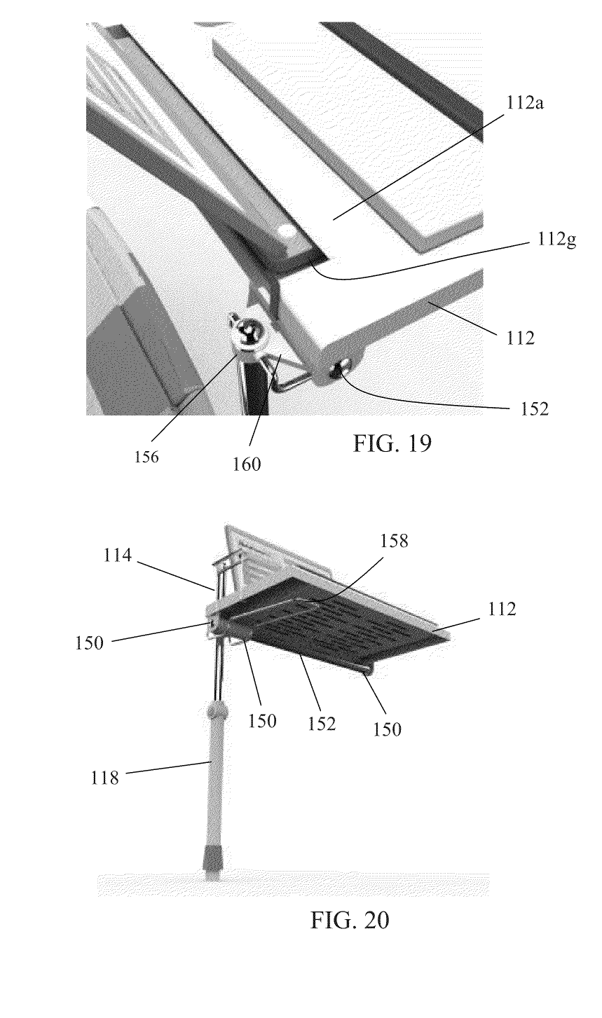

As best seen in FIGS. 15 and 19, similar to the first embodiment, opening 112g may extend into the upwardly facing side or support surface 112a of tray 112 to allow the display of the laptop to pivot to a generally closed position, such as shown in FIG. 15, so that the computer support station and computer can be folded into a stowed arrangement and also allow access to the on/off button of the laptop computer.

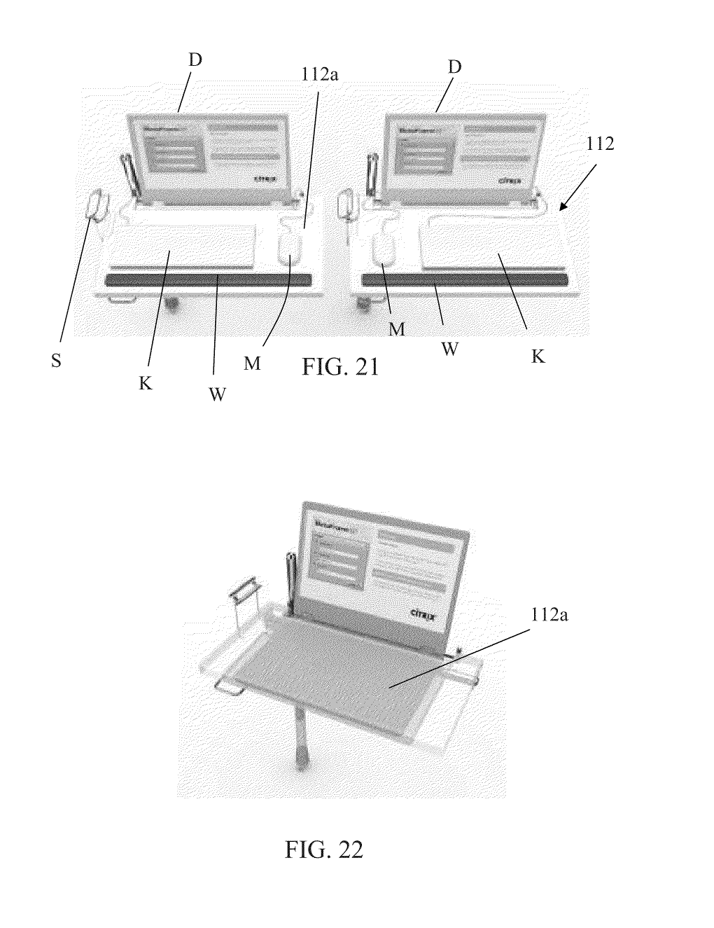

Referring to FIGS. 21 and 22, it should be understood that tray 112 may accommodate several different layouts for the work surface. For example, surface 112a, as previously noted in reference to the first embodiment, may support a full size keyboard K, mouse M, and further a wrist rest W. The arrangement of these accessories may be adapted to accommodate a left-handed person or a right-handed person, such as shown in FIG. 21. Furthermore, tray 112 may incorporate a scanner S to scan medications, or as noted previously the wrist band of the patient, to automatically upload information into the system or download information onto the screen of the display depending on the function performed by the caregiver. For example, medications may be scanned by scanner S, which medication is then documented into the laptop computer and may be forwarded onto a nurse call station or a records management system, as previously noted and, further, may provide a security check to ensure that the medication being given to the patient corresponds to the prescription for that particular patient. Furthermore, the keyboard, mouse, and wrist rest may be removed (such as shown in FIGS. 22-24) to provide a larger work surface, for example for handling prescriptions or performing other tasks.

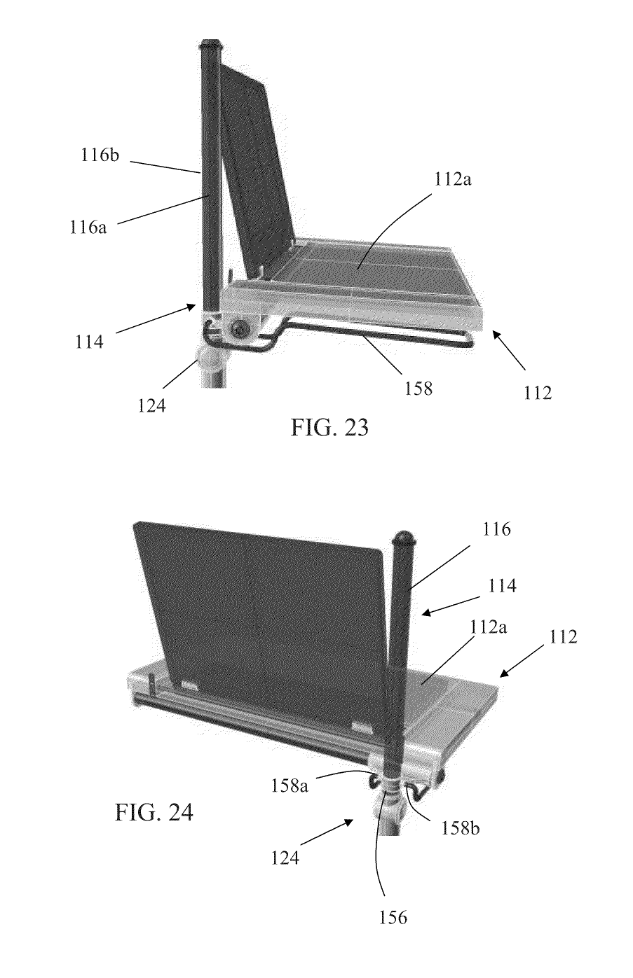

As best understood from FIGS. 23, and 24, collar 156 may slide down upper tubular member 116, which motion may be controlled by the gas spring incorporated into the column assembly. As shown, therefore, upper tubular member 116 may incorporate longitudinal guides along its opposed sides 116a, 116b to guide arms 158a and 158b of U-shaped lever 158 when lever 158 is moved upwardly or downwardly to depress the push button in the spring and to allow collar 156 to slide up or down tubular member 116.

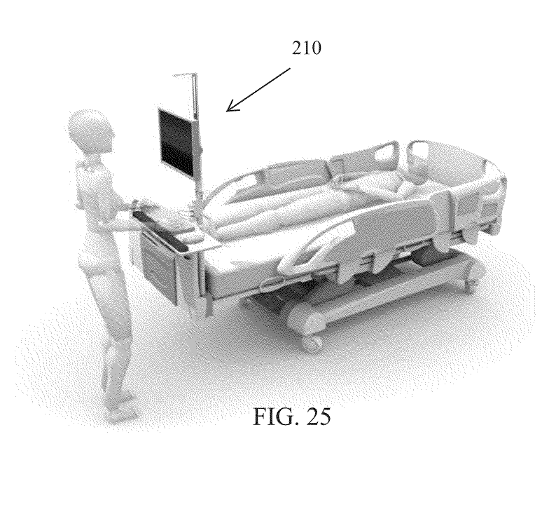

Referring to FIGS. 25-29, the numeral 210 generally designates another embodiment of the computer support station of the present invention. In contrast to the previous embodiment, tray 212 provides a work surface 212a for supporting a keyboard K, a mouse M, and a wrist rest W, with the computer incorporated into display D, which is in communication with keyboard K either through a wired connection or through a wireless connection, such as an RF or infrared connection.

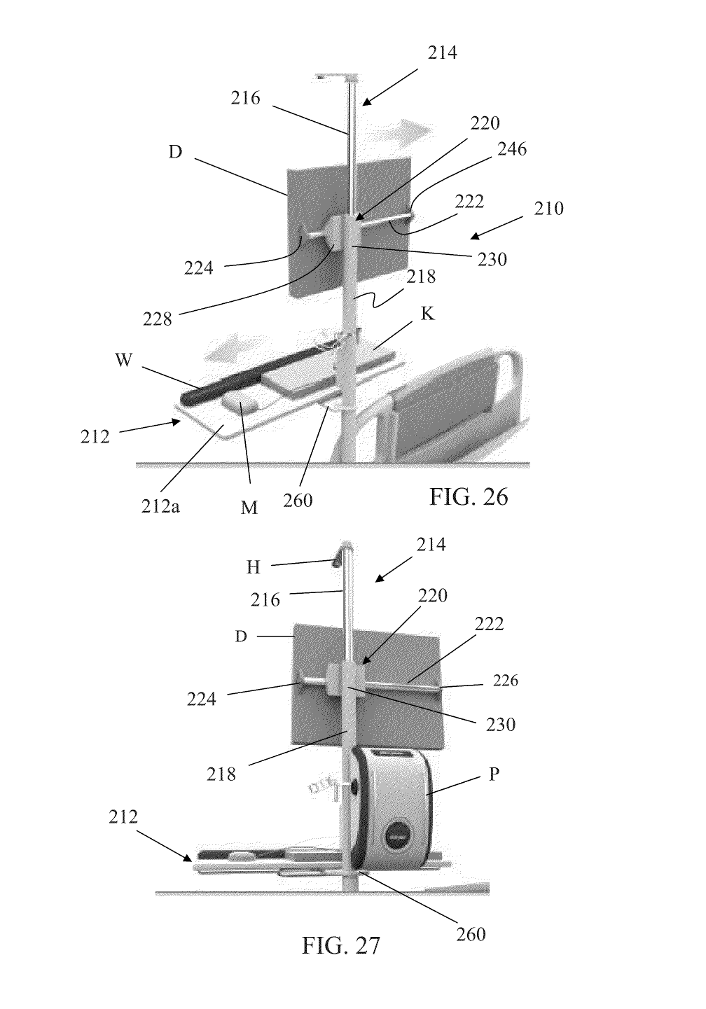

Similar to the previous embodiments, tray 212 is mounted to a column assembly 214, which provides for articulation of the display about a vertical axis, as well as a horizontal axis, and similarly includes a lower tubular member 218 that mounts into the footboard (FIG. 29). Upper tubular member 216 of column assembly 214 supports the combined computer and display D. As best seen in FIGS. 26 and 27, display D is mounted to upper tubular member 216 by a bracket assembly 220. Bracket assembly 220 may include a transverse guide rod 222, which is mounted between a pair of rearwardly extending flanges 224, 226 formed on the back of display D, and which forms a guide for moving display D laterally with respect to column assembly 214.

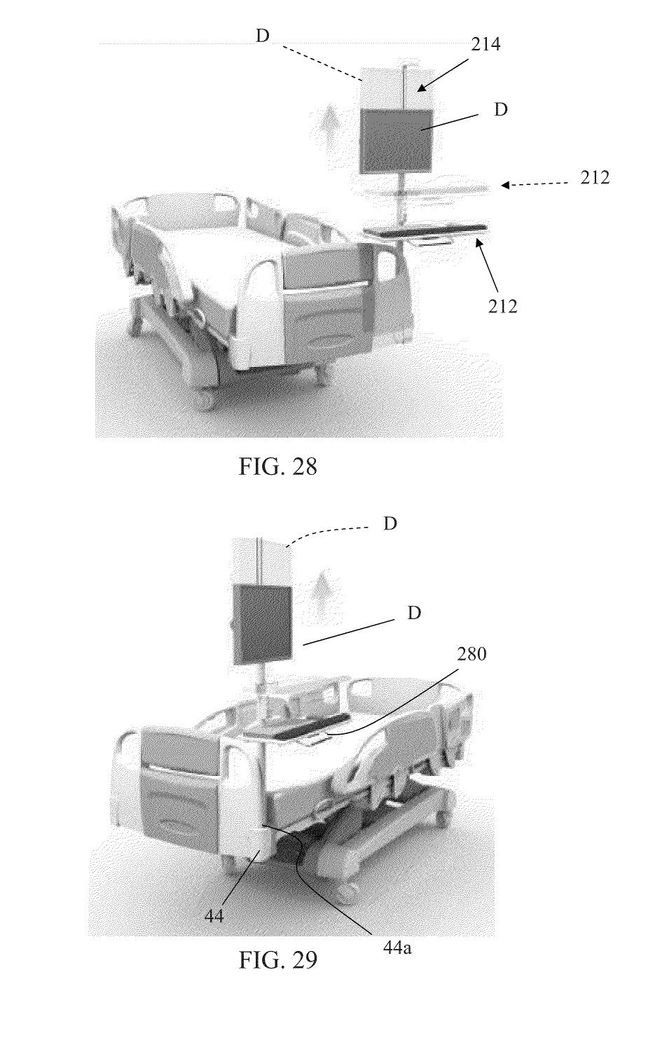

Bracket assembly 220 further includes a bracket 228, which is slidably mounted on and guided along rod 222 that allows the lateral adjustment of display D relative to column 214. Bracket 228 similarly includes a collar 230, which extends around tubular member 216 to allow vertical adjustment of display D along column 214. Each of these sliding connections may incorporate torque control mechanisms so that while the display may be moved, it requires a predetermined force to move it. Suitable torque control mechanisms are available as previously noted from Reell. In this manner, display D may be moved vertically relative to column assembly 214, such as shown in phantom in FIGS. 28 and 29, with its lowermost position shown in FIGS. 26 and 27 and its upper most position shown in phantom in FIGS. 28 and 29.

Tray 212 is similarly mounted to column assembly 214 by a bracket 260, which also provides for vertical adjustment of tray 212 relative to column assembly 214 and, further, optionally allows for rotation of tray 214 about the vertical axis of column assembly 214. Bracket 260 may also incorporate a torque control mechanism to restrict free rotation of the tray similar to display D.

Optionally, column assembly 214 may also incorporate a joint to provide infinite positioning and locking of an upper portion of column assembly 214 relative to the lower anchoring portion of column 214 to thereby allow the tray 212 to maintain its generally horizontal orientation even when the foot end of the bed is lowered, for example, to a cardiac or chair position. Further, column assembly 214 may also incorporate a gas spring in lower tubular member 218 to assist in the raising and lowering of tray 212. Similar to the previous embodiments, tray 212 may incorporate a handle 280, which is coupled to the push button on the rod end of the gas spring to allow a user to push or pull on the handle to adjust the height of the tray.

It should be understood that the column assemblies in any one of the computer support stations of the present invention may provide support for other accessories, including a pump (such as shown in FIG. 27) and, further, may incorporate a hook to suspend an IV bag.

While several forms of the invention have been shown and described, it should be appreciated that any of the features of one embodiment may be combined with any of the features of the other embodiments described herein. Furthermore, the shape of the various components forming the column assembly and brackets and the tray itself may be varied. These and other changes and modifications will be appreciated by those skilled in the relevant art. For example, a computer may be built into and enclosed the tray with the display mounted to the tray. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

The embodiments of the invention in which an exclusive property right or privilege is claimed are defined as follows:

1. A computer support station comprising:
a tray having a support surface, said tray adapted for mounting to a footboard of a hospital bed and being vertically or horizontally adjustable;
a computer;
a display in communication with said computer; and
a keyboard supported on said support surface in communication with said computer.

2. The computer support station according to claim 1, wherein said computer is configured for communication with the hospital bed based computer or a nurse call station or an EMR system.

3. The computer support station according to claim 1 wherein said tray is horizontally adjustable.

4. The computer support station according to claim 3, further in combination with a hospital bed, said bed having a footprint, and said tray being mounted at said footboard and being adjustable to a location within said foot print of said bed.

5. The computer support station according to claim 1, further in combination with a hospital bed, said bed having a bed-based power supply, said tray being mounted at said footboard, and said computer and said display powered by said bed-based power supply.

6. The computer support station according to claim 1, said computer comprising a portable computer, said station further in combination with a hospital bed, said bed having a bed-based computer, said portable computer in communication with said bed-based computer and operable to control or monitor one of more bed-based components.

7. The computer support station according to claim 1, said computer comprising a portable computer, said station further in combination with a hospital bed, said bed having a bed-based computer having bed-based applications, said portable computer in communication with said bed-based computer and operable to upload a bed-based application or update a bed-based application on said bed-based computer.

8. The computer support station according to claim 1, further comprising a laptop computer, said laptop computer providing said computer and said display, wherein said tray has a receptacle, said laptop computer base is housed in said receptacle, and said display is extendible from said tray, and said keyboard is in communication with said laptop.

9. The computer support station according to claim 1 wherein said tray includes a column assembly adapted to releasably mount said station to a hospital bed.

10. The computer support station according to claim 9, wherein said column assembly includes an articulatable upper portion and a fixed lower portion, said fixed lower portion being adapted to releasably mount said station to a hospital bed.

11. The computer support station according to claim 10, wherein said upper portion comprises a pair of nesting inner and outer tubular members to provide adjustment to the height of said tray.

12. The computer support station according to claim 11, wherein said upper portion includes a spring, such as a gas spring, to assist raising or lowering the tray.

13. The computer support station according to claim 12, wherein said tray supports an actuator for actuating said gas spring.

14. The computer support station according to claim 13, wherein said actuator comprises a lever.

15. A patient support comprising:
a frame;
a computer support station mounted to said frame, said computer support station including a tray having a work surface, a computer, a display in communication with said computer, and a keyboard supported on said support surface in communication with said computer, said tray being adapted so it can be reconfigured to a plurality of different positions to accommodate the reconfiguration of the patient support so that the orientation of the keyboard can remain the same despite the change in configuration of the bed.

16. The patient support according to claim 15, wherein said support surface extends beyond said keyboard to provide a work surface.

17. The patient support according to claim 15, wherein said tray includes a column assembly adapted to releasably mount said computer support station to said frame.

18. The patient support according to claim 17, wherein said column assembly includes an articulatable upper portion and a fixed lower portion, said fixed lower portion being adapted to releasably mount said computer support station to said frame.

19. The patient support according to claim 18, wherein said upper portion comprises a pair of nesting inner and outer tubular members to provide adjustment to the height of said tray.

20. The patient support according to claim 15, further comprising a spring, such as a gas spring, to assist raising or lowering said tray.

21. The patient support according to claim 20, further comprising an actuator for actuating said spring.

22. The patient support according to claim 21, wherein said actuator comprises a lever.

23. A method of monitoring and care of a patient comprising:
mounting a computer and a keyboard to a patient support;
allowing adjustment of said keyboard position or orientation of said keyboard to suit the user or maintaining the keyboard position or orientation of the keyboard when the patient support is reconfigured; and
providing assistance to the adjustment or maintaining to reduce the force needed to adjust or maintain the position of the keyboard.

24. A method of monitoring and care of a patient comprising:
mounting a computer and a keyboard on a patient support, the patient support having a footprint;
moving the keyboard within the footprint of the patient support to facilitate movement of the patient support.
